(19) United States
(12) Patent Application Publication
(10) Pub. No.: US 2006/0204169 A1
(43) Pub. Date: Sep. 14, 2006

(54) All-optical controllable photonic switch

(75) Inventor: Daqun Li, Miami, FL (US)

Correspondence Address: MICHAEL J. BUCHENHORNER, ESQ;HOLLAND & KNIGHT, 701 BRICKELL AVENUE, MIAMI, FL, 33131, US

(73) Assignees: New Span Opto-Technology, Inc.; Daqun Li

(21) Appl. No.: 11/075,776

(22) Filed: Mar. 9, 2005

(51) Int. Cl. G02B 6/26; H04B 10/12; G02B 6/42

(52) U.S. Cl. 385/16; 359/333; 385/17; 385/24; 359/341.1; 359/341.3

(57) ABSTRACT

A photonic switch matrix is disclosed. The photonic switch matrix includes a first pair of power splitters, each power splitter including one input and two output ports and a second pair of power splitters, each power splitter including two input ports and one output port. The photonic switch matrix further includes four optical fibers doped with gain controllable substances under light pumping, the four optical fibers connecting the first pair and the second pair of power splitters, wherein each input port of the second pair of power splitters is connected to an output port of the first pair of power splitters. The photonic switch matrix further includes four multiplexers, each multiplexer coupled with one of the four optical fibers, and at least one light pump connected to each multiplexer, wherein light pumped into a multiplexer defines an optical path of the photonic switch matrix.

### STATEMENT REGARDING FEDERALLY SPONSORED RESEARCH OR DEVELOPMENT

This invention was made with U.S. Government support under contract DASG60-03-C-0021 awarded by the U.S. Army Space and Missile Defense Command. The Government has certain rights in the invention.

### CROSS-REFERENCE TO RELATED APPLICATIONS

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of optics, and more particularly relates to the field of photonic switches for optical communication systems.

### BACKGROUND OF THE INVENTION

With the advent of the information era, modern optical communication systems are demanding more and more network capacity to process large volumes of information mixed with data, video, and audio signals. Dense wavelength division multiplexing (DWDM) and large-scale photonic switch matrices are two approaches for boosting overall network capacity. DWDM technology relies on the use of narrow signal channel spacing so that more channels can be utilized within a given wavelength span. DWDM technology, however, cannot evolve indefinitely because it will ultimately run into a technical limit in signal channel spacing. Another technical barrier for DWDM evolution is the chromatic dispersion effect causing signal overlap or cross talk between adjacent channels. A photonic switch matrix, by contrast, boosts the network capacity not by increasing the number of channels, but by enhancing the usage efficiency of existing channels through fast channel reconfiguration (i.e., switching). In principle, a photonic switch matrix does not suffer from evolution limitation and therefore can be cascaded to form a large-scale switch matrix, so long as the accumulated optical insertion loss is within the network overall loss budget. Large-scale switching formation and fast switch reconfiguration rates are the required characteristics for fast computing and image data processing in both military and commercial applications.

Existing photonic switches mainly rely on electro-optic (EO) or mechanical approaches such as the micro electromechanical systems (MEMS). EO switches have a potential of providing high-speed photonic switching operations. However, these switches are only suitable for small-scale cross-connect applications, because the overall optical insertion loss accumulated during device cascade for large-scale switch matrix formation is too large for practical use. By comparison, MEMS switches have the potential of forming large-scale photonic switch matrixes but at slow switching speed. Similarly, accumulated insertion loss and crosstalk issues are the limiting factors.

In addition, existing photonic switches as mentioned above are all operated with the aid of external voltage signals, and therefore these switches are in the category of electrical controllable photonic switches. One common drawback shared by these photonic switches is that they are sensitive to electro-magnetic interference (EMI). In uncontrolled operational environments where strong EMI sources may exist, electrical controllable photonic switches are not reliable. All-optical controllable photonic switches alleviate the EMI sensitivity by utilizing optical control signals for photonic switching operations. Despite the obvious technical attractions offered by an all-optical controllable photonic switch matrix, realization of photonic switches has been proven difficult. This is primarily impeded by the lack of suitable light-sensitive materials for practical all-optical photonic switching applications. Secondly, incorporation of light-sensitive materials into a large-scale photonic switch matrix with a compact device size is also not trivial, involving packaging and aligning a large number of control light sources. For these reasons, no viable solutions exist so far for the realization of an all-optical controllable large-scale photonic switch matrix with low insertion loss.

Very limited research and development efforts exist for the development of all-optical controllable photonic switches. Current efforts are based on integrated optic approaches with various planar waveguide structures. Compared to their electrical controllable counterparts, all-optical controllable photonic switches are inferior in terms of insertion loss, cross talk, switch speed, and device reliability. Thus, photonic switches are used solely for research purposes and are far from being used for practical applications.

Therefore, a need exists to overcome the problems with the prior art as discussed above, and particularly for an all-optical controllable large-scale photonic switch matrix with low insertion loss.

### SUMMARY OF THE INVENTION

Briefly, according to an embodiment of the present invention, a 2 by 2 photonic switch matrix is disclosed. The 2 by 2 photonic switch matrix includes a first pair of power splitters, each power splitter including one input and two output ports and a second pair of power splitters, each power splitter including two input ports and one output port. The photonic switch matrix further includes four optical fibers doped with gain controllable substances under light pumping, the four optical fibers connecting the first pair and the second pair of power splitters, wherein each input port of the second pair of power splitters is connected to an output port of the first pair of power splitters. The photonic switch matrix further includes four multiplexers, each multiplexer coupled with one of the four optical fibers, and at least one light pump connected to each multiplexer, wherein light pumped into a multiplexer defines an optical connection path of the photonic switch matrix.

According to the second embodiment of the present invention, an N by N photonic switch matrix is disclosed. The N by N photonic switch matrix includes a first set of N power splitters, each power splitter including one input and N output ports and a second set of N power splitters, each power splitter including N input ports and one output port. The photonic switch matrix further includes N² optical fibers doped with gain controllable substances under light pumping, the N optical fibers connecting the first set and the second set of power splitters, wherein each input port of the second set of power splitters is connected to an output port of the first set of power splitters. The photonic switch matrix further includes N² multiplexers, each multiplexer coupled with one of the N² optical fibers, and N² light pumps, each light pump connected to each multiplexer, wherein light pumped into a multiplexer defines an optical connection path of the photonic switch matrix.

According to the third embodiment of the present invention, an M by N photonic switch matrix is disclosed. The M by N photonic switch matrix includes a first set of M power splitters, each power splitter including one input and N output ports and a second set of N power splitters, each power splitter including M input ports and one output port. The photonic switch matrix further includes M×N optical fibers doped with gain controllable substances under light pumping, the M×N optical fibers connecting the first set and the second set of power splitters, wherein each input port of the second set of power splitters is connected to an output port of the first set of power splitters. The photonic switch matrix further includes M×N multiplexers, each multiplexer coupled with one of the M×N optical fibers, and M×N light pumps, each light pump connected to each multiplexer, wherein light pumped into a multiplexer defines an optical connection path of the photonic switch matrix.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a schematic drawing of a fundamental 1 by 2 all-optical controllable photonic switch with single-ended pumping, according to one embodiment of the present invention.

FIG. 2 is a revised schematic drawing of the switch of FIG. 1, but with double-ended pumping, according to one embodiment of the present invention.

FIG. 3 is a schematic drawing of a fundamental 2 by 2 all-optical controllable photonic switch of the present invention with single-ended pumping, according to one embodiment of the present invention.

FIG. 4 is a schematic drawing of a fundamental 2 by 2 all-optical controllable photonic switch with double-ended pumping, according to one embodiment of the present invention.

FIG. 5 is a schematic drawing of a 4 by 4 all-optical controllable photonic switch, according to one embodiment of the present invention.

FIG. 6 is a revised schematic drawing of a double-pumping scheme and two single-pumping schemes of one switching path out of total 16 switching paths, for the 4 by 4 photonic switch shown in FIG. 5, according to one embodiment of the present invention.

FIG. 7 is a schematic representation of an N by N all-optical controllable photonic switch, according to one embodiment of the present invention.

FIG. 8 is a schematic representation of an M by N all-optical controllable photonic switch, according to one embodiment of the present invention.

### DETAILED DESCRIPTION

The present invention provides an all-optical controllable photonic switch with substantial EMI immunity when the control lasers are not local. The present invention further provides a photonic switch with a potential for forming a large-scale photonic switch matrix with low overall insertion loss. The present invention further provides a cost-effective all-fiber-based photonic switch that contains no moving parts without wearing or bearing issues leading to high device reliability.

In one embodiment of the present invention, the switching operation is controlled by optical signals rather than electrical voltage signals for EMI immunity. Unlike MEMS photonic switches, the photonic switch of the present invention contains no moving parts for the removal of potential wearing or bearing issues to achieve long-term device reliability. Further, the photonic switch of the present invention can be fabricated at low cost with simple device packaging that does not involve tedious optical alignments or fiber pig-tailing. Also, the photonic switch of the present invention possesses minimum millisecond switching speed comparable to that of mechanical or MEMS photonic switches.

A splitter is a transmission coupling device for separately sampling either the forward (incident) or the backward (reflected) wave in a transmission line. A multiplexer is a device that combines multiple inputs at separate wavelengths into an aggregate signal to be transported via a single transmission channel. An optical fiber is a filament of transparent dielectric material, usually plastic or glass, and usually in circular cross section, that guides light through total internal reflection, or by photonic crystal or photonic band-gap structures. Erbium is one of the so-called rare-earth elements on the lanthanide series with an atomic number of 68. Erbium can be placed on an optical fiber for controlling gain, resulting in an erbium doped fiber (EDF). A light pump is an optical signal that excites the erbium atoms in an EDF to increase the intensity of light beams passing through. A laser pump is a device that produces coherent pumping light for erbium doped optical fibers. Input/output ports are the two ends of a photonic device that route optical signals from one end (input) to the other end (output).

In one embodiment of the present invention, an EDF-based all-optical controllable photonic switch matrix for large-scale (N by N) optical cross-connect applications is disclosed. The switch comprises: (A) N 1 by N splitters; (B) N N by 1 combiners; and (C) N² pieces of EDF of a certain length connecting the N² output ports of the 1 by N splitters and the N² input ports of the N by 1 combiners. In addition, N² 980 nanometer (hereinafter “nm”) laser pumps are multiplexed to one end of the N2 pieces of EDF cables with one-to-one correspondence by the aid of N² 980/1550 nm multiplexers. Optionally, another set of N² 980/1550 nm multiplexers can be multiplexed to the other end of the EDF cables for dual pumping purpose. In this optional configuration, N² 1 by 2 980 nm power splitters are used to share the same 980 nm laser pump at each EDF path for dual pumping purpose without the need to double the number of laser pumps for cost reduction. The addition of dual 980/1550 nm multiplexers at both ends of each EDF path also helps remove 980 nm pump leakage at both signal input and output ends. Due to the symmetric device configuration, the switching operation is bi-directional.

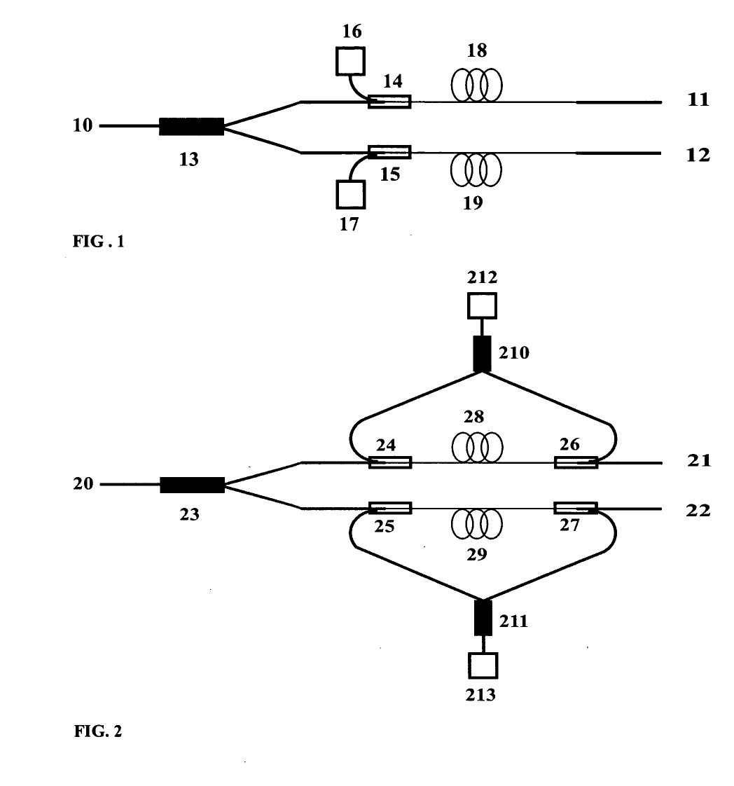

FIG. 1 is a schematic drawing of a 1 by 2 EDF all-optical controllable photonic switch with single-ended pumping, according to one embodiment of the present invention. In this configuration, an optical signal from input end 10 is first split into two beam paths of equal power by a 1 by 2 power splitter 13. Two pieces of EDF cables 18 and 19 are fusion spliced into the two beam paths, respectively, in connection with two output fiber ports 11 and 12. At each beam path, a 980/1550 nm multiplexer 14 or 15 multiplexes the 980 nm light pump from the laser pump 16 or 17 to the EDF cable 18 or 19. For switching operations from input end 10 to output end 11, laser pump 16 is turned on while laser pump 17 is turned off leading to optical amplification (“optical connection”) by EDF cable 18 and optical absorption (“optical disconnection”) by EDF cable 19.

When the EDF cable has a sufficient length, the accumulated optical absorption along the EDF becomes significant (typical attenuation of common EDF cables is around 5 dB/m) leading to effective optical disconnection along the fiber path 19. At the EDF path 18 with optical amplification, the pumping power from laser pump 16 is adjusted to a certain level so that the gain provided by EDF 18 compensates the splitting loss by the 1 by 2 power splitter 13. Thus, zero-loss optical switching from input end 10 to output end 11 can be achieved. Switching from input end 10 to output end 12 can be achieved in a similar manner. Since the switching operation in this configuration is bi-directional, the switch described above can also be operated reversibly.

The 1 by 2 EDF photonic switch shown in FIG. 1 uses a single-pumping scheme at each EDF path. One possible drawback of the single-pumping scheme is the remnant pump leakage at the other end of the EDF that could interfere with either the source or the detector in the networking systems. This potential problem can be alleviated by utilizing the double-pumping scheme shown in FIG. 2 below.

FIG. 2 is a revised schematic drawing of the switch of FIG. 1, but with double-ended pumping, according to one embodiment of the present invention. With the double-pumping scheme, remnant pump leakage at each end of the EDF path 28 or 29 is de-multiplexed from the signal path 20 and 21, or, 20 and 22 by the two pairs of 980/1550 nm multiplexers 24 and 25, or, 26 and 27 located at each end of the EDF path. Naturally, due to the double-pumping scheme, two 980 nm power splitters 210 and 211 are needed to split the power of the laser pumps 212 and 213 for the double-pumping purpose.

Another purpose of pumping scheme is to provide gain for optical amplification as required by a large-scale EDF photonic switch matrix in order to achieve low or no overall insertion loss. Actually, the optical gain provided by the pumping scheme in this configuration may well exceed the splitting loss of the 1 by 2 power splitter 23. Thus, the present invention possesses a dual-functionality of photonic switching and signal amplifying.

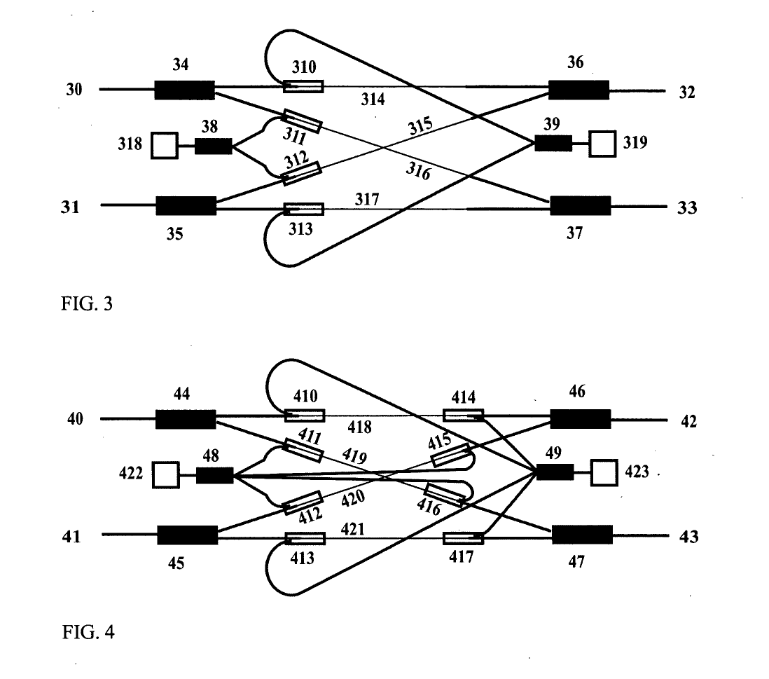

While FIGS. 1 and 2 describe an unsymmetrical 1 by 2 EDF photonic switch configuration, FIG. 3 illustrates a symmetrical 2 by 2 EDF cross-connect photonic switch, in one embodiment of the present invention.

FIG. 3 is a schematic drawing of a 2 by 2 EDF all-optical controllable photonic switch of the present invention with single-ended pumping, according to one embodiment of the present invention. As seen in FIG. 3, four 1 by 2 power splitters 34, 35, 36, and 37 are configured to form cross and bar connections between the two input ends 30/31 and two output ends 32/33. For cross-switch operations (30 to 33 and 31 to 32), laser pump 318 is turned on while laser pump 319 is turned off. The pumping power from laser pump 318 is split onto two paths by a 980 nm 1 by 2 power splitter 38, and then the split pumping beams are multiplexed to the two cross path EDF cables 315 and 316 by two 980/1550 nm multiplexers 311 and 312, respectively.

Similarly, for bar-switch operation (30 to 32, and 31 to 33), laser pump 319 is turned on while laser pump 318 is turned off. The 980 nm 1 by 2 power splitter 39 splits the pumping power into two paths and then the split pumping beams are multiplexed by two 980/1550 nm multiplexers 310 and 313 to two bar path EDF cables 314 and 317. The pump sharing scheme of this embodiment of the present invention is beneficial not only because it saves the cost for additional laser pumps, but also because it uses a single laser pump to control each switching state, thus avoiding synchronization issues between multiple laser pumps for switch control. With single-pumping, the 2 by 2 EDF photonic switch can operate bi-directionally.

The 2 by 2 EDF photonic switch shown in FIG. 3 uses the single-pumping scheme. The switch of FIG. 3 can be revised to adopt the double-pumping scheme as shown in FIG. 4.

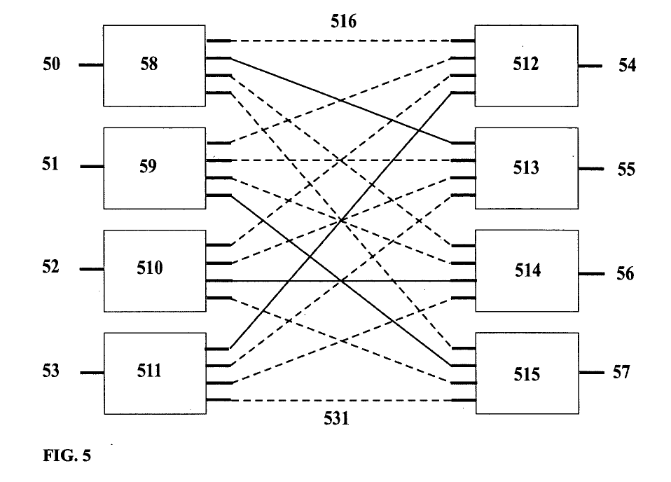

FIG. 4 is a schematic drawing of a 2 by 2 EDF all-optical controllable photonic switch with double-ended pumping, according to one embodiment of the present invention. FIG. 4 is similar to FIG. 3 except that the two 980 nm 1 by 2 power splitters in FIG. 3 are replaced with two 980 nm 1 by 4 power splitters 48 and 49 with the addition of additional four 980/1550 nm multiplexers 414, 415, 416, and 417 for double-pumping purpose. With the double-pumping scheme, the 2 by 2 EDF photonic switch shown in FIG. 4 is a truly symmetrical 2 by 2 bi-directional cross-connect photonic switch. The EDF photonic switch configuration of the present invention can be readily scaled up as demonstrated by the 4 by 4 EDF photonic switch shown in FIG. 5.

FIG. 5 is a schematic drawing of a 4 by 4 EDF all-optical controllable photonic switch, according to one embodiment of the present invention. In FIG. 5, the 4 by 4 EDF photonic switch is composed of eight 1 by 4 power splitters 58 to 515, and sixteen EDF paths 516 to 531. FIG. 5 shows one switching state (input 50 to output 55; input 51 to output 57; input 52 to output 56; input 53 to output 54) out of total 4!=4×3×2=24 switching states. Other components in this 4 by 4 EDF photonic switch, not shown in this figure for clarity, are the 980/1550 nm multiplexers, 980 nm 1 by 2 power splitters, and 980 nm laser pumps at each EDF path.

If the excess losses of the 1 by 4 power splitters can be neglected, each of the four EDF paths at switch-on state should provide 12 dB optical gain to compensate for the splitting and combining losses at both input and output ends. Under these circumstances, a loss-less 4 by 4 EDF photonic switch matrix is hence realized. With an increase in pumping power, a 4 by 4 EDF photonic switch with net optical amplification is achievable. However, excessive pumping power may result in uneven optical amplification among signals at different wavelengths leading to an increase in wavelength dependent loss (WDL). This arises from the gain characteristic of EDF under optical pumping. Two solutions to this problem exist. One is to insert a gain flattening filter at each EDF path to flatten the gain spectral curve of the EDF; the other is to select the EDF cable of a certain length so that both under-pumping and over-pumping of EDF are avoided leading to a flat gain spectral curve of the EDF.

Similarly, the pumping scheme for the 4 by 4 EDF photonic switch in FIG. 5 can be either single-pumping or double-pumping.

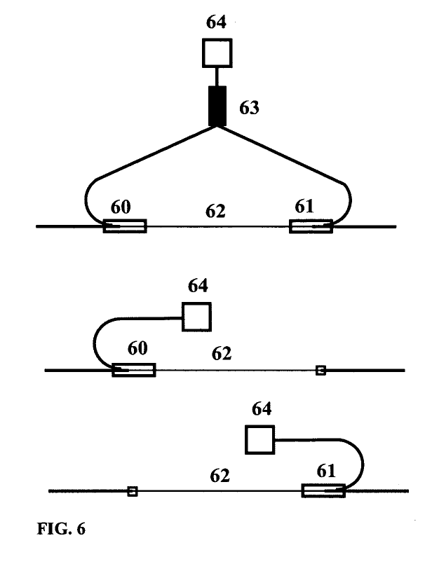

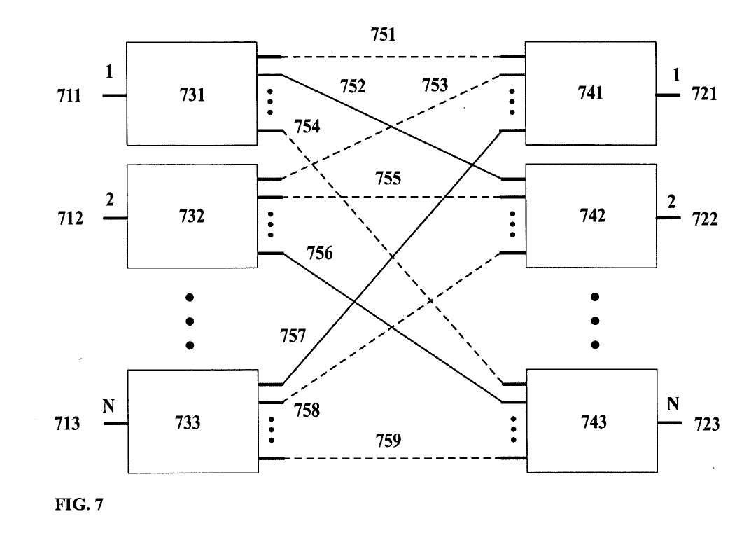

FIG. 6 is a revised schematic drawing of a double-pumping scheme and two single-pumping schemes of one EDF path out of total 16 EDF paths, for the 4 by 4 EDF photonic switch shown in FIG. 5, according to one embodiment of the present invention. FIG. 6 illustrates total three pumping possibilities (one double-pumping scheme and two single-pumping schemes) that can be used for one EDF path out of total 16 EDF paths. The double-pumping scheme pumps the two ends of the EDF path 62 from one laser pump 64 split by a 980 nm 1 by 2 power splitter 63. Naturally, two 980/1550 nm multiplexers 60 and 61 are included to multiplex the pumping light onto the EDF cable from both ends. As for single-pumping schemes, only one 980/1550 nm multiplexer either 60 or 61 is used to multiplex the pumping light from the pump 64 to either end of the EDF cable 62. Obviously, the pumping scheme shown in FIG. 6 should be applied to each EDF path of total 16 EDF paths to complete the 4 by 4 EDF photonic switch configuration.

An N by N EDF photonic switch configuration as shown in FIG. 7 can be formed similarly based on an embodiment of the present invention. FIG. 7 is a schematic representation of an N by N EDF all-optical controllable photonic switch, according to one embodiment of the present invention. In this configuration, 2N 1×N power splitters 731, 732, . . . , 733, and 741, 742, 743 are connected by N² EDF cables 751, 752, . . . , and 759. Similarly, double-pumping or single-pumping schemes can be chosen for each EDF path out of total N² EDF paths, as illustrated in FIG. 6. Optical cross-connections between input ports 711, 712, . . . , 713 and output ports 721, 722 . . . , 723 can be realized by turning on the laser pumps of the corresponding EDF paths while all other laser pumps of the remaining EDF paths are kept off.

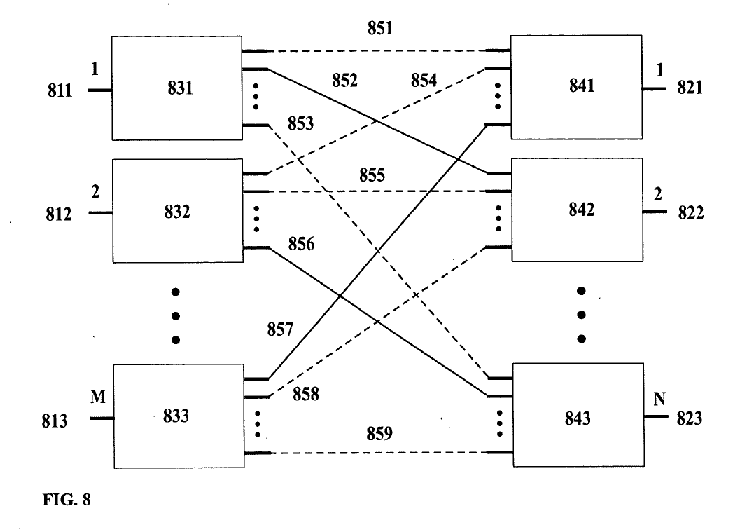

More generally, an M by N EDF photonic switch configuration as shown in FIG. 8 can be formed similarly based an embodiment of the present invention. FIG. 8 is a schematic representation of an M by N EDF all-optical controllable photonic switch, according to one embodiment of the present invention. In this configuration, M 1 by N power splitters 831, 832, . . . and 833, and N M by 1 power couplers 841, 842, . . . , and 843 are connected by M×N EDF cables 851, 852, . . . , and 859. Similarly, double-pumping or single-pumping schemes can be chosen for each EDF path out of total M×N EDF paths, as illustrated in FIG. 6. Optical cross-connections between input ports 811, 812, . . . , 813 and output ports 821, 822, . . . , 823 can be realized by turning on the laser pumps of the corresponding EDF paths while all other laser pumps of the remaining EDF paths are kept off.

The embodiment of the present invention mentioned above uses single 1 by N power splitters for optical power splitting and combining between the input and output ports. The illustrated single 1 by N power splitters can be further extended to cover multiple power splitters cascaded for the same functionality of 1 by N power splitting. For instance, a single 1 by 4 power splitter can be replaced by three 1 by 2 power splitters cascaded in serial to achieve the required 1 by 4 power splitting functionality. Thus, use of such multi-stage cascaded power splitters is contemplated as within the scope of the appended claims.

While the invention has been described in the context of EDF that represents erbium doped optical fiber, it will be readily understood by the skilled artisan that the term “EDF” can be interpreted to include any of erbium doped light guides such as an erbium doped waveguide (EDW) with either two-dimensional (planar) or three-dimensional (3D) light-wave circuitry configuration. Also, other components described such as the power splitters and multiplexers can be either all-fiber based or planar- or 3D-waveguide circuitry based. Thus, any light guided media that serve to provide a dual function of optical amplification and optical absorption under the control of pumping light are contemplated as within the meaning of the term “EDF” and such a configuration structure either all-fiber based or planar- or 3D-waveguide circuitry based is intended to be included within the scope of the invention.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A 2 by 2 photonic switch matrix, comprising:
a first pair of power splitters, each power splitter including one input and two output ports;
a second pair of power splitters, each power splitter including two input ports and one output port;
four optical fibers doped with gain controllable substances under light pumping, the four optical fibers connecting the first pair and the second pair of power splitters, wherein each input port of the second pair of power splitters is connected to an output port of the first pair of power splitters;
four multiplexers, each multiplexer coupled with one of the four optical fibers; and
at least one light pump connected to each multiplexer, wherein light pumped into a multiplexer defines an optical connection path of the photonic switch matrix.

2. The photonic switch matrix of claim 1, wherein a first light pump is connected to two of the four optical fibers and a second light pump is connected to another two of the four optical fibers.

3. The photonic switch matrix of claim 1, wherein each of the four optical fibers is an erbium doped optical fiber.

4. The photonic switch matrix of claim 1, wherein each of the four multiplexers is a 980/1550 nm multiplexer.

5. The photonic switch matrix of claim 1, wherein the at least one light pump is a laser pump

6. The photonic switch matrix of claim 5, wherein the laser pump is a 980 nm laser pump.

7. An N by N photonic switch matrix, comprising:
a first set of N power splitters, each power splitter including one input and N output ports;
a second set of N power splitters, each power splitter including N input ports and one output port;
N² optical fibers doped with gain controllable substances under light pumping, the N² optical fibers connecting the first set and the second set of power splitters, wherein each input port of the second set of power splitters is connected to an output port of the first set of power splitters;
N² multiplexers, each multiplexer coupled with one of the N² optical fibers; and
N² light pumps, each light pump connected to each multiplexer, wherein light pumped into a multiplexer defines an optical path of the photonic switch matrix.

8. The photonic switch matrix of claim 7, wherein each of the N² optical fibers connecting the first set and the second set of power splitters, is an erbium doped optical fiber.

9. The photonic switch matrix of claim 7, wherein each of the N² multiplexers is a 980/1550 nm multiplexer.

10. The photonic switch matrix of claim 7, wherein each of the N² light pumps is a laser pump.

11. The photonic switch matrix of claim 10, wherein the laser pump is a 980 nm laser pump.

12. An M by N photonic switch matrix, comprising:
a first set of M power splitters, each power splitter including one input and N output ports;
a second set of N power splitters, each power splitter including M input ports and one output port;
M×N optical fibers doped with gain controllable substances under light pumping, the M×N optical fibers connecting the first set and the second set of power splitters, wherein each input port of the second set of power splitters is connected to an output port of the first set of power splitters;
M×N multiplexers, each multiplexer coupled with one of the M×N optical fibers; and
M×N light pumps, each light pump connected to each multiplexer, wherein light pumped into a multiplexer defines an optical path of the photonic switch matrix.

13. The photonic switch matrix of claim 12, wherein each of the M×N optical fibers connecting the first set and the second set of power splitters, is an erbium doped optical fiber.

14. The photonic switch matrix of claim 12, wherein each of the M×N multiplexers is a 980/1550 nm multiplexer.

15. The photonic switch matrix of claim 12, wherein each of the M×N light pumps is a laser pump.

16. The photonic switch matrix of claim 15, wherein the laser pump is a 980 nm laser pump.
